(19) United States
(12) Patent Application Publication
(10) Pub. No.: US 2025/0118220 A1
(43) Pub. Date: Apr. 10, 2025

(54) STUDENT PERFORMANCE EVALUATION METHOD, EVALUATION SYSTEM, DATA PROCESSING DEVICE, AND STORAGE MEDIUM

(71) Applicant: Hengyuan ZHAO, Xi'an (CN)

(72) Inventors: Hengyuan ZHAO, Xi'an (CN); Guanyi GAO, Xi'an (CN); Yongkang KANG, Xi'an (CN); Huaizheng WANG, Xi'an (CN); Fan ZHANG, Xi'an (CN); Junfeng GAO, Xi'an (CN); Chen GUO, Xi'an (CN); Bo WEN, Xi'an (CN); Haoxuan WANG, Xi'an (CN)

(21) Appl. No.: 18/482,888

(22) Filed: Oct. 8, 2023

(51) Int. Cl. G09B 7/00

(52) U.S. Cl. CPC G09B 7/00

(57) ABSTRACT

The present disclosure provides a student performance evaluation method, an evaluation system, a data processing device, and a storage medium, which can comprehensively and truly evaluate student performance, the method includes: determining student ID information of each student, and storing the student ID information of each student in a preset database; generating a label patch corresponding to the student ID information of each student; associating the label patch with corresponding process-based assessment data of student, wherein the process-based assessment data includes daily homework performance and daily test performance, to represent daily learning performance of the student; using a readout module adapted to the label patch to obtain the process-based assessment data of student by reading the label patch; evaluating performance of each student based on the process-based assessment data of each student.

### TECHNICAL FIELD

The present disclosure relates to the field of educational technology, in particular to a student performance evaluation method, an evaluation system, a data processing device, and a storage medium.

### BACKGROUND OF THE PRESENT INVENTION

At present, the evaluation of students is mainly based on their exam scores. This evaluation method makes students' exam oriented awareness too heavy, resulting in a negative impact of learning only what is tested. Moreover, exam oriented classroom teaching also overlooks the cultivation of other abilities and cannot comprehensively reflect true performance of students.

Under this background, how to evaluate student performance has become particularly important and needs to be addressed by skilled person in the art.

### SUMMARY OF PRESENT INVENTION

In view of this, the present disclosure provides a student performance evaluation method, an evaluation system, a data processing device, and a storage medium, which can comprehensively and truly evaluate student performance. The method includes:
Determining student ID information of each student, and storing the student ID information of each student in a preset database;
Generating a label patch corresponding to the student ID information of each student;
Associating the label patch with corresponding process-based assessment data of student, wherein the process-based assessment data includes daily homework performance and daily test performance, to represent daily learning performance of the student;
Using a readout module adapted to the label patch to obtain the process-based assessment data of student by reading the label patch;
Evaluating performance of each student based on the process-based assessment data of each student.
Optionally, the student ID information includes a school code and a student code, wherein the student code includes a grade code, an arrangement code, and a subject code;
Wherein, for the same school code, the student code can be ranking.

Optionally, associating label patch with corresponding process-based assessment data of student, including:
Attaching the label patch to the corresponding daily homework files and daily test files related to the process-based assessment data of student to associate the label patch with the corresponding process-based assessment data of student.

Optionally, using the readout module adapted to the label patch to obtain the process-based assessment data of student by reading the label patch, including:
Determining the student list who submitted the daily homework files and the daily test files by reading the label patches, and obtain answer results of daily homework and daily test of each student;
Obtaining the daily homework performance and the daily test performance of the students based on the student list, the answer results of daily homework and daily test of each student.

Optionally, obtaining the daily homework performance and the daily test performance of the students based on the student list, the answer results of daily homework and daily test of each student, including at least one of the following:
Matching the answer results of each question in the daily homework file and the daily test file of each student in the student list with the answer to the corresponding question by a subject with the grading authority; determining the corresponding scores for the daily homework file and the daily test file of each student based on the matching results;
Determining the matching method with the answer of the corresponding question based on the question type of each question in the daily homework file and the daily test file of each student in the student list, so as to automatically match the answer result of the question with the pre-stored standard answers, then determining the score corresponding to the daily homework file and the score corresponding to the daily test file of each student in the student list based on the matching degree;
Determining a homework perfect attendance and a test perfect attendance of each student according to the information matching degree between the student list and the student ID information of each student stored in the database, and determining the daily homework performance and the daily test performance of the student according to the homework perfect attendance and the test perfect attendance of each student.

Optionally, the student performance evaluation method further includes:
Storing the answers of questions in the daily homework files and/or the daily test files that do not match the corresponding answers in a storage space corresponding to each label patch to form a set of mistakes collection.

Optionally, the student performance evaluation method further includes:
Forming a timestamp when reading the label patch, wherein the timestamp is used to represent the submission time of the daily homework file and the daily test file of each student.

Optionally, the student performance evaluation method further includes:
Reading the label patches to obtain attendance time data for each student;
When a scheduled time is reached, analyzing the attendance of each student based on the attendance time data of each student and a pre-set attendance time, wherein the scheduled time is a deadline for class.

Optionally, the label patch and the readout module communicate through near-field communication technology.

Optionally, evaluating performance of each student based on the process-based assessment data of each student includes:
Determining the daily homework grades and the daily test grades of each student based on the daily homework performance and the daily test performance of the student;
Determining the daily grades of each student based on their daily homework grades, pre-set weight coefficients corresponding to their daily homework grades, daily test grades, and pre-set weight coefficients corresponding to their daily test grades.

Optionally, the student performance evaluation method further includes:
Determining a ranking level of each student based on the daily grades of each student;
Mapping the grades of each student to a preset assignment range based on the ranking level of each student;
Determining the final grades of each student based on a preset scoring rule;
Determining an actual ranking level of each student based on the final grades of each student.

Optionally, the student performance evaluation method further includes:
Generating a distribution diagram and/or trend chart of daily grades of each student through analyzing and comparing the daily grades of each student;
and/or

Counting the daily grades of all students in the class, analyzing and comparing the daily grades of all students in the class, and then generating a distribution diagram and/or trend chart of the daily grades of the class.

Optionally, the student performance evaluation method further includes:
responding to a preset query instruction, determining a query authority of the inquirer based on a identity of the inquirer, so as to display a content corresponding to the query authority to the inquirer.

Optionally, responding to a preset query instruction, determining a query authority of the inquirer based on a identity of the inquirer, so as to display a content corresponding to the query authority to the inquirer, including:
If it is determined that the inquirer is the parent of the student, display the process-based assessment data of the student to the parents and teachers;
If it is determined that the inquirer is a homeroom teacher or substitute teacher, display the process-based assessment data of the class to the homeroom teacher or substitute teacher;
If it is determined that the inquirer is the school leader or the education bureau leader, display the process-based assessment data of the school to the school leader or the education bureau leader.

Optionally, the student performance evaluation method further includes:
Generating corresponding learning guidance suggestions based on the process-based assessment data of each student.

Optionally, the student performance evaluation method further includes:
Uploading the process-based assessment data of each student to a cloud server to store.

Optionally, the student performance evaluation method further includes:
Obtaining results-based assessment data of each student, wherein the results-based assessment data is suitable for characterizing exam scores of student;
Weighting the daily grades and the exam scores of each student to determine the grades of each student.

Optionally, the student performance evaluation method further includes:
Verifying the exam scores of each student based on the the daily grades of each student;
And/or

Verifying the daily grades of each student based on the exam scores of each student.

The present disclosure also provides a student performance evaluation system, including:
An information confirmation module, configured to determine the student ID information of each student and storing the student ID information of each student in a preset database;
A generation module, configured to generate label patches corresponding to the student ID information of each student;
An association module, configured to associate the label patches with the corresponding the process-based assessment data of student;
The readout module, which is adapted to the label patches, configured to obtain the process-based assessment data of student by reading the label patches;
The evaluation module, configured to evaluate the performance of each student based on the process-based assessment data of student.

Optionally, the label patch and the readout module communicate through near-field communication technology.

The present disclosure also provides a data processing device, including a memory and a processor, wherein the memory stores computer instructions that is able to be run on the processor, and the processor executes the steps of student performance evaluation described in any of the aforementioned embodiments when running the computer instructions.

The present disclosure also provides a computer-readable storage medium on which computer instructions are stored, and the computer instructions execute the steps of student performance evaluation described in any of the aforementioned embodiments when running.

By using the student performance evaluation solution of the present disclosure, by generating label patches corresponding to the student ID information of student, the label patches can be associated with the corresponding process-based assessment data of student. Therefore, when using a readout module adapted to the label patches to read the label patches, the process-based assessment data of student can be obtained. As the process-based assessment data includes daily homework performance and daily test performance, and it can be used to represent daily learning performance of student. Compared to the method of evaluating grades of students based on exam scores, based on the process-based assessment data of student, it can comprehensively and truly evaluate student performance.

Further, as the student ID information includes the school code and the student code, the student code includes the grade code, the arrangement code, and the subject code, thus, it is possible to confirm the only student corresponding to it based on the student ID information. Moreover, for the same school code, by making the student code arrangeable, it is possible to flexibly adjust the form of the student code, improve the user experience, and make the student performance evaluation method more universal.

Further, by attaching the label patches to the corresponding daily homework files and daily test files related to the process-based assessment data of student, the label patches can be associated with the corresponding process-based assessment data of student. Subsequently, by reading the label patches, the process-based assessment data of student can be accurately identified and reading efficiency can be improved.

Further, by reading the label patches, the student list of students who submitted daily homework files and daily test files can be determined, and the answer results of daily homework and daily test of each student can be obtained. Based on the student list, answer results of daily homework and daily test of each student, the daily homework performance and the daily test performance of each student can be obtained, therefore, based on daily homework and daily tests of students, their daily grades can be scored, which can truly reflect the grades of each student.

Further, by matching the answer results of each question in the daily homework file and the daily test file of each student in the student list with the answer to the corresponding question by a subject with the grading authority, then determining the corresponding scores for the daily homework file and the daily test file of each student based on the matching results. So that teachers and other users can rate the daily grades of each student, truly reflecting their grades, thereby improving the accuracy of student performance evaluation. The matching method with the answer of the corresponding question is determined based on the question type of each question in the daily homework file and the daily test file of each student in the student list, so as to automatically match the answer result of the question with the pre-stored standard answers, then the score corresponding to the daily homework file and the score corresponding to the daily test file of each student in the student list can be determined based on the matching degree. On the one hand, it can improve the efficiency of grading, it can also reduce errors caused by manual correction, on the other hand, it is convenient for teachers and other users to rate the daily grades of each student, truly reflecting their grades, thereby improving the accuracy of student performance evaluation. Based on the information matching degree between the student list and the student ID information of each student stored in the database, a homework perfect attendance and a test perfect attendance of each student can be determined, so that teachers and other users can rate their daily grades and truly reflect their grades, thereby improving the accuracy of student performance evaluation.

Further, by storing the answers to questions in daily homework files and/or daily test files that do not match the corresponding answers in the storage space corresponding to each label patch, a set of mistakes collection can be formed. This enables students to conduct intensive training on the questions they have made mistakes, identify and fill in gaps, and thus improve learning quality.

Further, a timestamp is formed when reading the label patch, as the timestamp is used to represent the submission time of the daily homework file and the daily test file of each student, so that the submission time of the daily homework file and the daily test file of each student can be reconfirmed based on the timestamp to avoid misjudgment caused by abnormal reading operations.

Further, by reading the label patches, attendance time data of each student can be obtained. When a scheduled time is reached, the attendance of each student can be analyzed based on the attendance time data of each student and a pre-set attendance time. As the scheduled time is a deadline for class, the attendance rate of each student can be determined through the above method.

Further, by enabling the label patch and the readout module to communicate through near-field communication technology, the reading efficiency can be improved.

Further, based on the daily homework performance and the daily test performance of the student, the daily homework grades and the daily test grades of each student can be determined, thereby more reasonably determining the daily grades of each student based on the pre-set weight coefficients corresponding to the daily homework grades and the pre-set weight coefficients corresponding to the daily test grades.

Further, based on the daily grades of each student, the ranking level of each student can be determined, and the grades of each student can be mapped to the preset assignment interval. Through the preset scoring rule, the final grades of each student can be determined, and the actual ranking level of each student can be determined based on the final grades of each student. Using the above dual scoring process, it is possible to determine the grades of each student without disclosing their scores.

Further, by responding to a preset query instruction, a query authority of the inquirer can be determined based on a identity of the inquirer, so as to display a content corresponding to the query authority to the inquirer, thereby preventing the inquirer from viewing data beyond their authority and improving security.

Further, results-based assessment data can represent exam scores of student. By weighting the daily grades and the exam scores of each student, considering both process-based assessment data and results-based assessment data, the accuracy of student performance evaluation can be further improved.

Further, based on the daily grades of each student, it is possible to verify their exam scores, and/or be able to verify the daily grades of each student based on their exam scores. The use of the above dual verification process can enable teachers and parents to better understand the true learning situation of students, and also provide reference for schools to investigate student exam fraud.

### DESCRIPTION OF THE DRAWINGS

FIG. 1 is a flowchart of a student performance evaluation method in an embodiment of the present disclosure;

FIG. 2 is a flowchart for obtaining the process-based assessment data of student in an embodiment of the present disclosure;

FIG. 3 is a flowchart for determining the daily grades of each student in an embodiment of the present disclosure;

FIG. 4 is another flowchart for determining the daily grades of each student in an embodiment of the present disclosure;

FIG. 5 is a schematic diagram of the student performance evaluation method for a specific application scenario in an embodiment of the present disclosure;

FIG. 6 is a structural schematic diagram of a student performance evaluation system in an embodiment of the present disclosure;

FIG. 7 is a structural schematic diagram of a data processing device in an embodiment of the present disclosure.

### DETAILED DESCRIPTION OF PREFERRED EMBODIMENTS

The present disclosure provides a student performance evaluation solution that can comprehensively and truly evaluate student performance based on their process-based assessment data. Specifically, by generating label patches corresponding to the student ID information of each student, the label patches can be associated with the corresponding process-based assessment data of student. Therefore, when using a readout module adapted to the label patches to read the label patches, the process-based assessment data of student can be obtained. As the process-based assessment data includes daily homework performance and daily test performance, and it can be used to represent daily learning performance of student, compared to the method of evaluating student performance based on exam scores, it can comprehensively and truly evaluate student performance based on the process-based assessment data of student.

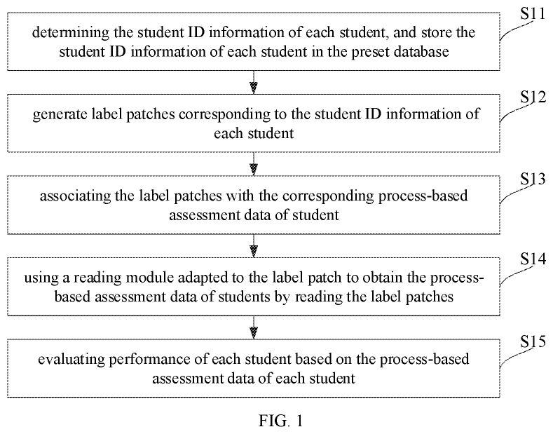

In the present disclosure, as shown in FIG. 1, a flowchart of a student performance evaluation method is shown. In some embodiments, the following methods can be used to evaluate the student performance:
S11, determining the student ID information of each student, and store the student ID information of each student in the preset database.

Specifically, a school or class often has multiple students. To facilitate the evaluation of each student performance, student ID information can be established for each student, and considering the possibility of students with duplicate names, by establishing student ID signals, different students can also be distinguished and their student ID information can be stored.

Preferably, the student ID information of each student can also be stored in a preset database for easy access at any time.

Preferably, the database may be one or more of distributed databases, data warehouses, JSON databases, etc. The present disclosure does not impose any restrictions on the type of database, as long as it can store the student ID information of each student.

Preferably, the student registration information of each student can be determined using preset coding rules based on the student registration data provided by any school.
S12, generate label patches corresponding to the student ID information of each student.

Specifically, using step S11, electronic versions of student ID information for each student can be generated. For ease of carrying and reading, corresponding paper version label patches can be generated.

Preferably, the student ID information of each student can be written into the corresponding electronic circuit to generate the label patch.

For example, based on the characteristics of homework and test papers, the label patch can be bent, which makes it easy to carry and has high stability.

The label patch can be an NFC patch.
S13, associating the label patches with the corresponding process-based assessment data of student.

Specifically, the label patch contains the student ID information of student, which can be associated with the corresponding process-based assessment data of student. Through the label patch, the student information can be obtained.

In some embodiments, the process-based assessment data can include daily homework performance and daily test performance, which can be used to represent daily learning performance of students.

Wherein, the daily homework performance can refer to the homework completion assigned to students by teachers and other educators, and the daily test performance can refer to the performance of students in various testing scenarios.

Preferably, the daily homework performance can include: homework quality, homework attendance rate, and homework revision frequency.

The daily test performance can include: daily test scores, test revision frequency, and classroom test performance.

The daily test performance may also include the quality of classroom notes, which can be flexibly adjusted according to actual needs.
S14, using a readout module adapted to the label patch to obtain the process-based assessment data of students by reading the label patches.

Specifically, the label patch is associated with the corresponding process-based assessment data of student, which means that the label patch has a one-to-one correspondence with each student. By using a readout module adapted to the label patch, the process-based assessment data of each student can be obtained.

In some embodiments, the readout module may use various communication methods to read the label patches.

Optionally, the label patch and the readout module communicate through near-field communication (NFC) technology, and the use of near-field communication technology has the advantages in fast reading speed, compact peripheral readout module, and low usage cost, which are exactly what is needed in the application scenario of student registration.

In addition, non-contact communication technology has extremely high flexibility and can effectively cope with various uncontrollable variables in scenarios, making it easy to promote and use.

In some embodiments, the label patch and readout module may also communicate through bluetooth, wireless network (WiFi), ZigBee, wireless local area network (WLAN), and other means.
S15, evaluating performance of each student based on the process-based assessment data of each student.

Specifically, the process-based assessment data can represent the daily learning performance of students, so based on the process-based assessment data of each student, their performance can be evaluated.

By adopting the student performance evaluation method provided by the present disclosure, taking into account the daily homework performance and daily test performance of students, compared to the method of evaluating student performance based on exam scores, based on the process-based assessment data of each student, the student performance can be comprehensively and truly evaluated.

Further, conducting process evaluation on students can help solve the problem of missing process evaluation links in the smart campus system, fill the market gaps, and guide students to strengthen moral cultivation and enhance their overall quality.

In some embodiments, the student ID information may include a school code and a student code, where the school code represents the school name, and the student code may include a grade code, arrangement code, and subject code.

Optionally, the numbering rule for student ID information defaults to ABCD, wherein A represents the school code, B represents the grade code in the student code, C represents the arrangement code in the grade code, and D represents the subject code in the student code.

Further, the representation of each code can be set according to actual needs.

For example, A can be a 3-digit school code arranged in ascending order starting from 001, such as 011 for the first high school and 002 for the second high school.
B can be a 2-digit grade code, such as 01 for first grade and 10 for senior 1.
C can be a 3-digit arrangement code arranged in ascending order starting from 001. In some examples, if the arrangement code overflows, then a new grade code is specified. Using this overflow redistribution method can effectively shorten the number length, reduce system costs, and make large-scale popularization possible.
D can be a 2-digit account code. The theory can be ranking into 256 different subjects (this volume), such as Mathematics 1, Mathematics 2, Physics 1, Chemistry 4, etc., which is sufficient for use.

The representation of each code described in the above examples is only for illustrative purposes and is intended to demonstrate that using the student performance evaluation method in the present disclosure can determine the student ID information of students and establish identity identification for each student.

Preferably, for the same school code, the student code can be ranking.

Specifically, in order to adapt to local conditions, personalized adjustments can be made to schools based on specific circumstances. For example, while supporting the school code to remain unchanged, schools can arrange their own student code to improve user experience and make student performance evaluation methods more universal.

When confirming the student ID information of each student, it can be automatically uploaded to the cloud for remote dual backup storage in different locations.

By using the above method, when determining the student ID information of student, it is possible to generate label patches corresponding to the student ID information of each student.

In some embodiments, the label patch can be associated with the corresponding process-based assessment data of student in the following way:
Attaching the label patch to the corresponding daily homework files and daily test files related to the process-based assessment data of student to associate the label patch with the corresponding process-based assessment data of student.

Specifically, label patches that can read data have the ability to be torn and stuck, making it possible to attach label patches to daily homework and test files in a very short amount of time. And by associating label patches with the corresponding process-based assessment data of student, and subsequently reading the label patches, the process-based assessment data of student can be accurately identified and the reading efficiency can be improved.

Preferably, as mentioned earlier, the label patch can be bent, so how to flip and bend daily homework and test files will not cause the label patch to fail or the information cannot be read, which can improve the service life of the label patch.

In some embodiments, when the label patch is associated with the corresponding process-based assessment data of student, the process-based assessment data of student can be obtained by reading the label patch.

More specifically, referring to the flowchart of obtaining the process-based assessment data of students in the present disclosure shown in FIG. 2, in some embodiments, the following steps can be performed:
S21, by reading the label patches, determining the list of students who submitted daily homework and daily test files, and obtain the answer results of daily homework and daily test of each student.

Specifically, on the one hand, since the label patch corresponds to the student ID information, by reading the label patch, the student corresponding to the label patch can be determined, and thus the list of students submitting daily homework and daily test files can be determined. On the other hand, by correcting and verifying the daily homework and test files of each student on the student list, the results of daily homework and test can be obtained.
S22, obtaining the daily homework performance and the daily test performance of the students based on the student list, the answer results of daily homework and daily test of each student.

Specifically, due to the fact that the student list can represent the students who submitted daily homework and daily test files, and the results of daily homework and daily test responses can represent the understanding of the knowledge learned, based on the above three factors, it can truly reflect the actual daily homework and daily test performance of students, and thus score the daily grades of students, to truly reflect the grades of each student.

In some embodiments, multiple methods can be used to obtain daily homework and daily test information of students.

For example, a subject with grading authority matches the answer results of daily homework file and daily test file of each student in the student list with the corresponding question answers. Based on the matching results, the corresponding scores for daily homework and daily test file of each student are determined.

Specifically, by reading the label patches, it is possible to identify the students who submitted the daily homework and daily test files this time. Therefore, the subject with correction authority (such as the teacher) can match the answer results of each question in the daily homework and daily test files of students with the corresponding answers (i.e. correction). Based on the matching results, It is possible to determine the scores corresponding to the daily homework and daily test files of each student, which can reflect their daily grades.

Preferably, teachers and other entities with grading authority can review the daily homework and test files of students through user terminal data such as tablets and personal computers, and input evaluation scores through keyboard, mouse, stylus, and other methods.

By using the above method, teachers and other users can score daily grades of students based on their daily homework and test results, which can truly reflect grades of students and improve the accuracy of student performance evaluation.

For example, based on the question type of each question in the daily homework file and the daily test file of each student in the student list, the matching method with the answer of the corresponding question can be determined, so as to automatically match the answer result of the question with the pre-stored standard answers, then determining the score corresponding to the daily homework file and the score corresponding to the daily test file of each student in the student list based on the matching degree.

Specifically, the matching method with the answer of the corresponding question can be determined based on the question type of each question in the daily homework file and the daily test file of each student in the student list, by matching the answer results of each question in the daily homework file and the daily test file of each student in the student list with the answer to the corresponding question by a subject with the grading authority, then determining the corresponding scores for the daily homework file and the daily test file of each student based on the matching results. So that teachers and other users can rate the daily grades of each student, truly reflecting their grades, thereby improving the accuracy of student performance evaluation. The matching method with the answer of the corresponding question is determined based on the question type of each question in the daily homework file and the daily test file of each student in the student list, so as to automatically match the answer result of the question with the pre-stored standard answers, then the score corresponding to the daily homework file and the score corresponding to the daily test file of each student in the student list can be determined based on the matching degree. On the one hand, it can improve the efficiency of grading, it can also reduce errors caused by manual correction, on the other hand, it is convenient for teachers and other users to rate the daily grades of each student, truly reflecting their grades, thereby improving the accuracy of student performance evaluation. Based on the information matching degree between the student list and the student ID information of each student stored in the database, a homework perfect attendance and a test perfect attendance of each student can be determined, so that teachers and other users can rate their daily grades and truly reflect their grades, thereby improving the accuracy of student performance evaluation.

As an optional example, when the question type of each question is known, the matching method with the corresponding answer can be determined based on the question type. For questions with objective questions, the answer results of the question are automatically matched with the pre-stored standard answer, and the corresponding score of the question is determined based on the matching degree. For questions with subjective question types, the evaluation score input by the subject account with grading authority can be obtained as the score for the question.

For example, for objective questions such as multiple-choice questions and fill in the blank questions, the corresponding score can be determined based on whether the answer results of the multiple-choice or fill in are consistent with the standard answer. Uncertain multiple-choice questions or multiple-choice questions are mostly based on the principle of completely consistent scores with standard answers. If the score for certain multiple-choice questions or multiple-choice questions in certain test papers is not determined based on the rule of perfect matching, but based on the degree of matching, the corresponding score can be obtained. For example, if the answer result is not equal to but included in the standard answer, half of the score can be obtained; if it is completely consistent with the standard answer, the entire score for this question can be obtained; if it is not completely matched or included in the standard answer and contains incorrect options, no score will be given.

Further, for objective questions, in addition to obtaining the evaluation score of the corresponding question, it is also possible to display whether the corresponding answer results are correct through different identifiers. For example, the answer results can be displayed in different colored fonts. For questions with correct answers, the color of the answer results can be changed to green. For questions with incorrect answers, the answer results can be changed to red font.

For example, based on the information matching between the student list and the student ID information stored in the database, the homework attendance rate and test attendance rate of each student is determined. Based on the homework attendance rate and test attendance rate of each student, the daily homework performance and daily test performance of the student is determined.

Specifically, the student list should match the information of the student ID information of each student stored in the database. If there is a lack of students in the student list, it indicates that the student has not submitted daily homework and daily test files this time. Correspondingly, the student has a low attendance rate for homework and test, which can determine that the daily homework and daily test performance of this student is poor and can be given a lower score.

By using the above method, daily grades of students can be scored based on their homework and test attendance rates, which can truly reflect their grades and improve the accuracy of student performance evaluation.

The above description of obtaining daily homework and daily test of students is only an example to illustrate that based on attendance and answering results of students, their daily grades can be determined.

Further, for questions in daily homework files and/or daily test files where the answers to the questions do not match the corresponding answers, they can be stored in the storage space corresponding to each label patch to form a set of mistakes collection. This allows students to conduct intensive training on the questions they have made mistakes, identify and fill in gaps, and thus improve learning quality.

More specifically, based on the corresponding relationships between established and stored questions and knowledge points, the questions in the wrong question bank can be classified and stored according to the knowledge points, so as to understand the mastery of each knowledge point by the respondents, and then targeted learning can be carried out on the weak links of the corresponding knowledge points, which is more conducive to the improvement of teaching quality.

Further, considering the impact of other adverse factors (such as poor communication environment and inability to establish communication), there may be situations where the label patch cannot be read, or user believes that the label patch has been read but not actually read, which makes it impossible to accurately evaluate daily homework and testing performance of students.

Based on this, in some embodiments, when reading the label patch, a timestamp is formed, which is used to represent the submission time of daily homework file and daily test file of each student.

Specifically, regardless of whether the label patch can be read correctly or not, a timestamp is formed when reading the label patch. As the timestamp can represent the submission time of daily homework and daily test files of each student, the submission time of daily homework and daily test files of of each student can be confirmed twice based on the timestamp, to avoid mis judgment caused by reading abnormalities (such as damaged label patches, abnormal reading equipment, etc.).

Preferably, a timestamp can be stamped on the daily homework and/or daily test files of student to indicate that the student has submitted the daily homework and daily test files.

Preferably, the student performance evaluation method of the present disclosure can also be used as an attendance machine.

As an example, the attendance of each student can be confirmed as follows:
Reading the label patches and obtain attendance time data for each student; When the scheduled time is reached, the attendance status of each student is analyzed based on their attendance time data and pre-set attendance time, wherein the scheduled time is the deadline for class.

Specifically, when reading the label patch, the current reading time can be displayed. At this time, the current reading time can be used as the attendance time data of student for this time. When the scheduled time is reached, stop to obtain the attendance time data of any student, and the attendance status of each student can be analyzed based on their attendance time data and pre-set attendance time.

Since the scheduled time is the class deadline, which means that the attendance time of each student has been obtained before or during the class, it can be determined whether the student is late for the class.

Preferably, considering the influence of weather or transportation factors, attendance requirements can be appropriately relaxed. For example, when the difference between attendance time data and the class deadline is less than the set difference, it can be considered that students are not late and have a good attendance rate.

By using the student performance evaluation method in the above example, the process-based assessment data of students can be determined, and based on the process-based assessment data of each student, their performance can be evaluated.

Referring to FIG. 3, in some embodiments, the daily grades of each student can be determined as follows.
S31, determining the daily homework and test scores of each student based on their daily homework and test scores.

Specifically, daily homework and daily tests of student can represent their understanding of the knowledge learned in daily life. Based on their performance in daily homework and daily tests, each student can be graded as their daily homework and daily test scores.
S32, determining the daily grades of each student based on their daily homework grades and pre-set weight coefficients corresponding to their daily homework grades, daily test grades, and pre-set weight coefficients corresponding to their daily test grades.

Specifically, considering that different factors have different proportions in daily grades of students, weight coefficients for daily test scores and daily homework scores can be pre-set, which can more reasonably determine the daily grades of each student and more accurately reflect their daily grades.

For example, if the daily homework score is N1, its corresponding weight coefficient is q1; If the daily test score is N2 and its corresponding weight coefficient is q2, then the daily score N=N1*q1+N2*q2.

Preferably, the weight coefficient corresponding to daily test scores can be greater than the weight coefficient corresponding to daily homework scores.

The above calculation method for determining daily grades of students is only an example and is used to illustrate that daily grades of students can be determined based on their daily homework scores and daily test scores. Preferably, other methods can also be used.

For example, it is possible to calculate the weighted scores of daily homework and daily tests, perform a root sign operation on the product of the two, and use the calculation result as the daily score of student.

Furthermore, different weight coefficients can be set for different dimensions of assessment.

TABLE 1
Weight Coefficients Corresponding to Different
dimensions of assessments and Their Representations

| Serial | Dimensions of | Weight | |
|---|---|---|---|
| Number | assessment | coefficient | Indication |
| 1 | homework | 0.2 | learning |
| | quality | | effect |
| 2 | Full attendance | 0.1 | Learning |
| | rate of | | habits |
| | homework | | |
| 3 | Homework | 0.1 | Learning |
| | revision times | | attitude |
| 4 | Daily test | 0.2 | learning |
| | scores | | effect |
| 5 | Test revision | 0.2 | Learning |
| | times | | attitude |
| 6 | Class | 0.2 | learning |
| | performance | | interest |

From Table 1, it can be seen that the quality of homework and daily test scores can reflect learning outcomes of students, and their corresponding weight coefficients can both be 0.2. The homework attendance rate can reflect learning habits of students, and its corresponding weight coefficient can be 0.1. The number of homework revisions can reflect learning attitudes of students, and its corresponding weight coefficient can be 0.1. The number of test revisions can reflect learning attitude of students, and its corresponding weight coefficient can be 0.2. Classroom performance can reflect learning interests of students, and its corresponding weight coefficient can be 0.1.

The types of dimensions of assessment in Table 1 are only examples, and the coefficients of each dimensions of assessment are also examples.

Furthermore, in order to actively respond and not disclose grades, the solution provided by the present disclosure can use rank levels to replace grades of students.

Specifically, based on the daily grades of each student, the ranking level of each student can be determined. Based on the ranking level of each student, the grades of each student can be mapped to a preset assignment interval. According to the preset scoring rules, the final grades of each student can be determined, and then the actual ranking level of each student can be determined based on their final grades.

That is to say, the process of double scoring (i.e. assigning grades according to their rank and ranking again after assigning grades) can be used to determine the grades of each student without disclosing their scores.

Preferably, a stage-by-stage analysis of the grades of each student or class can also be conducted to determine the changes in their grades during that period.

For example, it is possible to analyze and compare the daily grades of each student, and generate a distribution diagram and/or trend chart of their daily grades.

Specifically, daily grades of students at various time periods (day, month, quarter, year) can be counted, and a distribution diagram and/or change trend diagram of daily grades can be generated. Through the distribution diagram and/or change trend diagram of daily grades, it can reflect daily grades of students and also reflect the stability of their daily grades.

For example, counting the daily grades of all students in the class and analyzing and comparing the daily grades of all students in the class, generating a distribution diagram and/or trend chart of the daily grades of the class.

Specifically, the daily grades of all students in the class at each time period (day, month, quarter, year) can be counted, and a schematic diagram and/or trend chart of the daily grade distribution of the class can be generated. Through the schematic diagram and/or trend chart of the daily grade distribution, the daily grade of the class can be reflected, and the stability of the daily grade of the class can also be reflected, facilitating the comparison of teaching quality.

By using the above method, detailed analysis and comparison of process-based assessment data can be carried out, resulting in the issuance of a comprehensive assessment report on the class learning performance on that day, a personal assessment report on student learning performance, etc. Based on this data, reports on the year-on-year and month on month changes of the class and student learning performance on that day can be obtained.

Furthermore, process-based assessment data of students can be stored for inquirers to access.

In some embodiments, considering the identities of different inquirers, the data they can query should be different. Therefore, corresponding permissions need to be set to prevent different levels of inquirers from exceeding their authority to view data and improve security.

Preferably, the student performance evaluation method further includes: responding to a preset query instruction, determining a query authority of the inquirer based on a identity of the inquirer, so as to display a content corresponding to the query authority to the inquirer.

Specifically, for different identities of the inquirers, their corresponding query authority are different, and when the identities of the inquirers are determined, only the contents corresponding to their query authority are provided.

For example, if it is determined that the inquirer is a parent of a student, the process-based assessment data of the student is displayed to the parent.

For further example, if it is determined that the inquirer is a classroom teacher or a substitute teacher, the classroom teacher or substitute teacher is presented with the process-based assessment data for the class that he or she leads.

For further example, if it is determined that the inquirer is a school leader or an education bureau leader, the process-based assessment data of the school in which the school is located is displayed to the school leader or the education bureau leader.

In short, when the user needs to view data, they can respond to the preset query instructions and return the data that meets the requirements to the user terminal. During the process, permission review will be conducted based on the login information included in the user request to ensure that the user cannot view data beyond their authority.

Wherein, user permissions are generally set according to parents, subject teachers, homeroom teachers, subject preparation team leaders, grade directors, school education administrative departments, higher-level education administrative departments, and support granting temporary permissions for temporary teaching and research tasks, educational supervision, etc., making student performance evaluation methods more scalable.

From the above content, it can be seen that the student process-based assessment data can reflect their daily grades. Therefore, in some embodiments, corresponding learning guidance suggestions can also be generated based on the process-based assessment data of each student to improve teaching quality.

For example, for some students, their classroom performance may be poor, and they can be reminded to pay attention to listening and actively participate in class activities during class.

Further, in order to achieve continuous monitoring of student process-based assessment data, the student performance evaluation method of the present disclosure can also include: uploading the process-based assessment data of each student to a cloud server and storing it.

Wherein, cloud servers can be one of Amazon Web Service (AWS), Alibaba Cloud, and Tencent Cloud. This embodiment does not limit the types of cloud servers.

Furthermore, wireless communication units such as Bluetooth, WiFi, NFC, ZigBee, WLAN, etc. can be used to upload student process-based assessment data to the cloud server.

Wired communication can also be used to upload the process-based assessment data of current students to the cloud server.

Further, in order to facilitate relevant personnel to obtain student process-based assessment data more intuitively, the student performance evaluation method of the present disclosure can also include: displaying process-based assessment data of students.

More specifically, student process-based assessment data can be displayed through upper computers, display screens, or other display devices that can display images and/or text.

Furthermore, in order to further improve the accuracy of student performance evaluation, grades of students can also be determined based on both process-based assessment data and results-based assessment data.

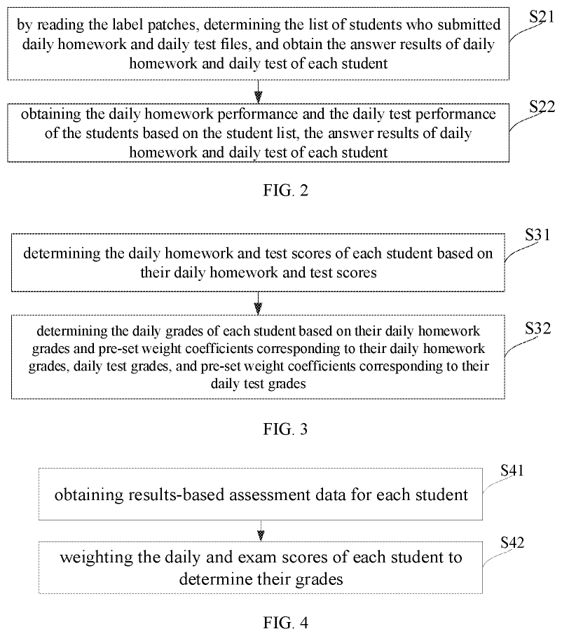

Referring to another flowchart for determining student grades in this embodiment shown in FIG. 4, in some embodiments, student grades can be determined as follows:
S41, obtaining results-based assessment data for each student.

Wherein, the results-based assessment data is suitable for representing exam scores of students.

Preferably, multiple methods can be used to obtain results-based assessment data for each student.

For example, results-based assessment data for each student can be obtained from pre-generated exam form.

For example, manually uploading exam scores to obtain results-based assessment data for each student.
S42, weighting the daily and exam scores of each student to determine their grades.

Specifically, weight coefficients for daily grades and exam grades can be set, and the weighted grades can be obtained based on daily grades and their weight coefficients, exam grades and their weight coefficients, to serve as the final grades for students.

Due to the consideration of both process-based assessment data and results-based assessment data in determining student grades, the above method can further improve the accuracy of student performance evaluation.

Further, the inventors found a corresponding relationship between daily grades and exam scores of students. For example, student daily performance is good, and correspondingly, their exam scores are better. For example, student daily grades are relatively poor, and correspondingly, their exam scores are also relatively poor.

Based on this, the student performance evaluation method of the present disclosure can also include: verifying the exam scores of each student based on their daily performance; And/or verify the daily scores of each student based on their exam scores.

By adopting the above dual verification process, teachers and parents can better understand the true learning situation of students, and also provide reference for schools to investigate student exam fraud.

To facilitate the understanding of the method of determining grades of students based on both process-based assessment data and results-based assessment data in this embodiment, the following is a detailed illustration through a specific embodiment.

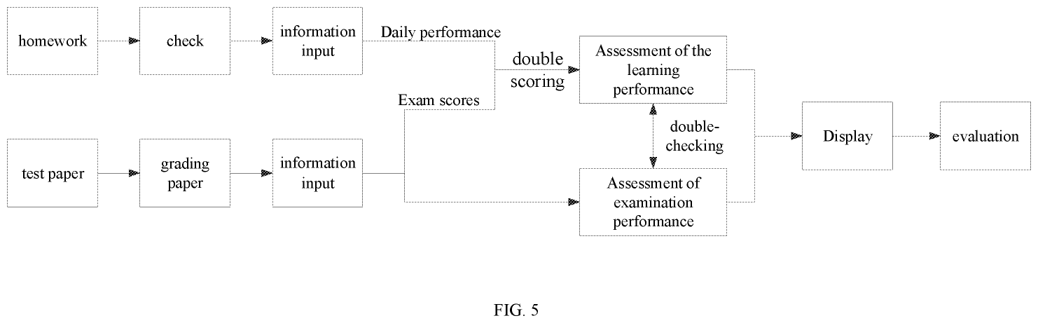

As shown in FIG. 5, for the branch where the process-based assessment data is located, by reading the label patches, the submitted homework can be obtained (it should be noted that the homework here is a broad concept, which can include daily teacher assigned homework, temporary classroom tests, class exams, etc. to explain the things that students complete to complete learning tasks), and then the teacher can verify the homework performance of students, and based on the homework performance, determine the daily grades of each student, and input their daily grades into the cloud server.

For the branch where the results assessment data is located, by obtaining and submitting test papers (it should be noted that the test paper here is a broad concept that can include the test papers used in school organized exams, the test papers used in education bureau organized exams, etc.), teachers can grade the papers to obtain answers of students, and determine the exam scores of each student based on the answers. At the same time, the student exam scores are recorded into the cloud server.

Further, it is possible to perform a double scoring operation on daily and exam scores (specific content can be seen in the previous embodiment), representing student grades by rank, and obtaining the evaluation of each student academic and exam performance. Due to the fact that academic performance evaluation can represent student performance in daily learning, and exam performance evaluation can represent student learning performance over a period of time, there is a corresponding relationship between the two. Therefore, a double check operation can be performed on academic performance evaluation and exam performance evaluation to determine whether they can truly reflect grades of students.

After the above process, grades can be displayed to students, teachers, school leaders, or relevant personnel such as the Education Bureau, and comprehensive and authentic evaluations of students can be made based on the results obtained from process-based assessment data and results-based assessment data.

This disclosure also provides a student performance evaluation system corresponding to the above student performance evaluation method. The following is a detailed introduction through specific embodiment, referring to the attached figures.

The student performance evaluation system described below can be considered as a functional module required to implement the student performance evaluation method provided in this disclosure. The content of the student performance evaluation system described below can be compared to the content of the student performance evaluation method described above.

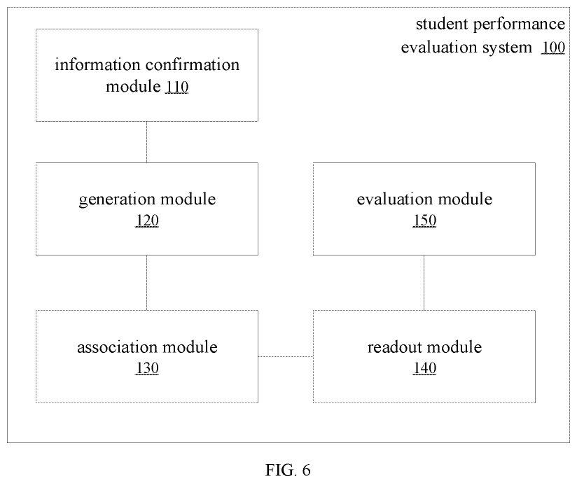

As shown in FIG. 6, in some embodiments, the student performance evaluation system 100 may include:
An information confirmation module 110, configured to determine the student ID information of each student and storing the student ID information of each student in a preset database;
A generation module 120, configured to generate label patches corresponding to the student ID information of each student;
An association module 130, configured to associate the label patches with the corresponding the process-based assessment data of student;
The process-based assessment data includes daily homework and daily tests, which are used to represent daily learning performance of students;
The readout module 140, which is adapted to the label patches, configured to obtain the process-based assessment data of student by reading the label patches;
The evaluation module 150, configured to evaluate the performance of each student based on the process-based assessment data of student.

Specifically, by using the student performance evaluation system 100 mentioned above, it can generate label patches corresponding to the student ID information by a generation module 120, and then association module 130 to associate the label patches with the corresponding student process-based assessment data. Due to the compatibility between the readout module 140 and the label patch, it is possible to obtain the process-based assessment data of students by reading the label patches. As the process-based assessment data includes daily homework and daily test performance, and can be used to represent students daily learning performance, compared to the method of evaluating grades of students based on exam scores, the evaluation module 150 is based on student process-based assessment data, so as to comprehensively and truthfully evaluate grades of students.

Preferably, the information confirmation module can use the student registration data provided by the school to determine the student registration information of each student using preset coding rules.

For example, student ID information can include school code and student code, wherein the school code represents the school name, and the student code can include grade codes, arrangement codes, and subject codes.

Further, for the same school code, the student code can be ranking.

Preferably, the association module can attach the label patch to the corresponding daily homework files and daily test files related to the student process-based assessment data, in order to associate the label patch with the corresponding student process-based assessment data.

Specifically, due to the tear-off and adhesive properties of label patches that can read data, label patches can be attached to daily homework and test files in a very short amount of time. And by associating label patches with the corresponding student process-based assessment data, and subsequently reading the label patches, the student process-based assessment data can be accurately identified and the reading efficiency can be improved.

In some embodiments, the readout module can obtain the process-based assessment data of students in the following ways:
A1) Determine the list of students who submitted daily homework and daily test documents by reading the label patches, and obtain the answer results of daily homework and daily test of each student.
A2) Based on the student list and the results of daily homework and daily test of each student, obtain the daily homework performance and daily test performance of the students.

Wherein, the specific process can be seen in the previous embodiments, and will not be further described here.

Preferably, the evaluation module can determine the daily homework and daily test scores of each student based on their daily homework performance and daily test performance. Then, based on the pre-set daily homework scores and their corresponding weight coefficients, the daily test scores and their corresponding weight coefficients, the daily grades of each student can be determined. The specific process can be seen in the previous embodiments, and will not be further described here.

In some embodiments, the student performance evaluation system can also be used as an attendance machine, and the specific working principle can be seen in the previous embodiment.

Preferably, the student performance evaluation system of the present disclosure can also include a query display module, which is configured for responding to preset query instructions and determining the query authority of the inquirer based on their identity, in order to show the content corresponding to their query authority to the inquirer.

Further, the student performance evaluation system can communicate with the cloud server to upload and store the process-based assessment data of each student to the cloud server, allowing for continuous monitoring of the student process-based assessment data.

In some embodiments, the label patch and the readout module communicate through near-field communication technology. Due to the advantages of fast reading speed, compact peripheral reading mechanism, and low usage cost, near-field communication technology is precisely what is needed in the application scenario of student registration. Moreover, non-contact technology provides it with extremely high flexibility, which can effectively cope with various uncontrollable variables in scenarios, making it easy to promote and use.

Further, the label patch can be an NFC patch, and the corresponding readout module can be an NFC card reader.

Preferably, the NFC card reading device can be composed of a central control chip and a card reading circuit, wherein the central control chip can be implemented using a small and low-cost printed circuit board.

When the label patch is an NFC patch, it can be based on a preset management system (such as the Github version), using an editor that is compatible with the management system (such as Visual Studio Code), and cooperating with an integrated development environment (such as Arduino IDE) to complete operations including reading label patches and writing data.

Further, in order to improve the stability and economy of NFC card reading devices, the hardware design needs to be on a breadboard for easy debugging and portability. The circuit on the breadboard is designed according to the needs of reading data.

After completing the development environment testing, the circuit board design integration environment can be used for schematic drawing, circuit optimization, PCB board design, and hardware porting to obtain an NFC card reading device.

In traditional solutions, when using an NFC card reading device, it is usually accompanied by a hard radio frequency card. However, setting such hardware in the workbook is undoubtedly impractical, as considering the flipping and bending of the workbook will result in the failure of the hard radio frequency card or the inability to read information.

Based on this, an alternative solution for foldable NFC patches has been developed based on the characteristics of student workbooks. For ease of portability and high stability, the NFC patch that can read data can be torn and stuck, and approximately a paper thick label patch can be attached to the workbook in seconds. No matter how the workbook is flipped or bent, the NFC patch will not fail or the information cannot be read.

Further, compared to the traditional NFC hard radio frequency card solution, the NFC label patch applied in this embodiment has significant advantages such as low power consumption, low pollution, and low cost, making its large-scale popularization a reality.

To facilitate the understanding of the working principle of the middle school student performance evaluation system in this embodiment, the following is a detailed explanation through an example.

Firstly, writing data with student ID information into the NFC patch, and attaching the label patch with written data on the corresponding homework book of student. During operation, first pressing the reset button to initialize, then using this device to scan the NFC patches on the homework one by one, and finally pressing the confirm button to display the student ID of the student who has not submitted the homework, which can determine the student homework attendance rate. Based on the student homework attendance rate, the daily performance of student may be rated.

It should be noted that after scanning the NFC patches on the homework book one by one, the answer results of the homework book can also be verified to determine the daily grades of each student. The specific process can be seen in the previous example.

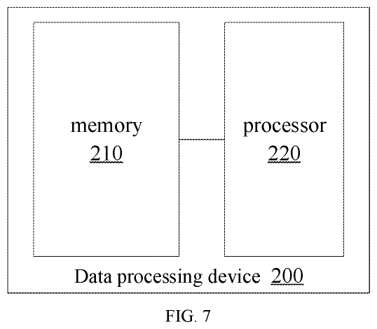

As shown in FIG. 7, this embodiment disclosure also provides a data processing device 200, which including a memory 210 and a processor 220, wherein the memory stores computer instructions that is able to be run on the processor, and the processor executes the steps of student performance evaluation described in any of the aforementioned embodiments when running the computer instructions.

The embodiment disclosure also provides a computer-readable storage medium on which computer instructions are stored, and the computer instructions execute the steps of student performance evaluation described in any of the aforementioned embodiments when running.

The computer-readable storage medium described in the embodiments of the present disclosure may include, for example, any suitable type of memory unit, memory device, memory item, memory medium, storage device, storage item, storage medium, and/or storage unit, such as memory, removable or non removable medium, erasable or non erasable medium, writable or rewritable medium, digital or analog medium, hard disk, soft disk, compact disc read-only memory (CD-ROM), compact disk recordable (CD-R), compact disk rewritable (CD-RW), compact disc, magnetic medium, magneto-optical medium, removable storage card or disk, various types of digital versatile disc (DVD), magnetic tape, cassette tape, etc.

Computer instructions may include any suitable type of code implemented by using any suitable high-level, low-level, object-oriented, visual, compiled, and/or interpreted programming language, such as source code, compiled code, interpreted code, executable code, static code, dynamic code, encrypted code, etc.

The specific implementation manner, working principle, specific functions and effects of the system and device in the embodiments of this disclosure can be referred to in the corresponding method of the embodiments.

1. A student performance evaluation method, comprising:
determining student ID information of each student, and storing the student ID information of each student in a preset database;
generating a label patch corresponding to the student ID information of each student;
associating the label patch with corresponding process-based assessment data of student, wherein the process-based assessment data includes daily homework performance and daily test performance, to represent daily learning performance of the student;
using a readout module adapted to the label patch to obtain the process-based assessment data of student by reading the label patch;
evaluating performance of each student based on the process-based assessment data of each student.

2. The student performance evaluation method according to claim 1, wherein the student ID information comprising a school code and a student code, wherein the student code comprising a grade code, an arrangement code, and a subject code;
wherein, for the same school code, the student code can be ranking.

3. The student performance evaluation method according to claim 1, wherein associating the label patch with corresponding process-based assessment data of student, comprising:
attaching the label patch to the corresponding daily homework files and daily test files related to the process-based assessment data of student to associate the label patch with the corresponding process-based assessment data of student.

4. The student performance evaluation method according to claim 3, wherein using the readout module adapted to the label patch to obtain the process-based assessment data of student by reading the label patch, comprising:
determining the student list who submitted the daily homework files and the daily test files by reading the label patches, and obtain answer results of daily homework and daily test of each student;
obtaining the daily homework performance and the daily test performance of the students based on the student list, the answer results of daily homework and daily test of each student.

5. The student performance evaluation method according to claim 4, wherein obtaining the daily homework performance and the daily test performance of the students based on the student list, the answer results of daily homework and daily test of each student, comprising at least one of the following:
matching the answer results of each question in the daily homework file and the daily test file of each student in the student list with the answer to the corresponding question by a subject with the grading authority; determining the corresponding scores for the daily homework file and the daily test file of each student based on the matching results;
determining the matching method with the answer of the corresponding question based on the question type of each question in the daily homework file and the daily test file of each student in the student list, so as to automatically match the answer result of the question with the pre-stored standard answers, then determining the score corresponding to the daily homework file and the score corresponding to the daily test file of each student in the student list based on the matching degree;
determining a homework perfect attendance and a test perfect attendance of each student according to the information matching degree between the student list and the student ID information of each student stored in the database, and determining the daily homework performance and the daily test performance of the student according to the homework perfect attendance and the test perfect attendance of each student.

6. The student performance evaluation method according to claim 5, wherein the student performance evaluation method further comprising:
storing the answers of questions in the daily homework files and/or the daily test files that do not match the corresponding answers in a storage space corresponding to each label patch to form a set of mistakes collection.

7. The student performance evaluation method according to claim 4, wherein the student performance evaluation method further comprising:
forming a timestamp when reading the label patch, wherein the timestamp is used to represent the submission time of the daily homework file and the daily test file of each student.

8. The student performance evaluation method according to claim 4, wherein the student performance evaluation method further comprising:
reading the label patches to obtain attendance time data for each student;
when a scheduled time is reached, analyzing the attendance of each student based on the attendance time data of each student and a pre-set attendance time, wherein the scheduled time is a deadline for class.

9. The student performance evaluation method according to claim 1, wherein the label patch and the readout module communicate through near-field communication technology.

10. The student performance evaluation method according to claim 1, wherein the evaluating performance of each student based on the process-based assessment data of each student comprising:
determining the daily homework grades and the daily test grades of each student based on the daily homework performance and the daily test performance of the student;
determining the daily grades of each student based on their daily homework grades, pre-set weight coefficients corresponding to their daily homework grades, daily test grades, and pre-set weight coefficients corresponding to their daily test grades.

11. The student performance evaluation method according to claim 10, wherein the student performance evaluation method further comprising:
determining a ranking level of each student based on the daily grades of each student;
mapping the grades of each student to a preset assignment range based on the ranking level of each student;
determining the final grades of each student based on a preset scoring rule;
determining an actual ranking level of each student based on the final grades of each student.

12. The student performance evaluation method according to claim 10, wherein the student performance evaluation method further comprising:
generating a distribution diagram and/or trend chart of daily grades of each student through analyzing and comparing the daily grades of each student;
counting the daily grades of all students in the class, analyzing and comparing the daily grades of all students in the class, and then generating a distribution diagram and/or trend chart of the daily grades of the class.

13. The student performance evaluation method according to claim 10, wherein the student performance evaluation method further comprising:
responding to a preset query instruction, determining a query authority of the inquirer based on a identity of the inquirer, so as to display a content corresponding to the query authority to the inquirer.

14. The student performance evaluation method according to claim 13, wherein responding to a preset query instruction, determining a query authority of the inquirer based on a identity of the inquirer, so as to display a content corresponding to the query authority to the inquirer.

15. The student performance evaluation method according to claim 10, wherein the student performance evaluation method further comprising:
uploading the process-based assessment data of each student to a cloud server to store.

16. The student performance evaluation method according to claim 10, wherein the student performance evaluation method further comprising:
obtaining results-based assessment data of each student, wherein the results-based assessment data is suitable for characterizing exam scores of student;
weighting the daily grades and the exam scores of each student to determine the grades of each student.

17. The student performance evaluation method according to claim 16, wherein the student performance evaluation method further comprising:
verifying the exam scores of each student based on the the daily grades of each student;
verifying the daily grades of each student based on the exam scores of each student.

18. A student performance evaluation system, comprising:
an information confirmation module, configured to determine the student ID information of each student and storing the student ID information of each student in a preset database;
a generation module, configured to generate label patches corresponding to the student ID information of each student;
an association module, configured to associate the label patches with the corresponding the process-based assessment data of student;
a readout module, which is adapted to the label patches, configured to obtain the process-based assessment data of student by reading the label patches.

19. The student performance evaluation system according to claim 18, wherein the label patch and the readout module communicate through near-field communication technology.
